(19) United States
(12) Patent Application Publication
(10) Pub. No.: US 2017/0052780 A1
(43) Pub. Date: Feb. 23, 2017

(54) Methods and Apparatus to Adapt Legacy Applications to Target Platforms

(71) Applicant: ZIH Corp., Lincolnshire, IL (US)

(72) Inventors: Nathan J. Clevenger, Burnsville, MN (US); Benjamin P. Horgen, Rochester, MN (US); Brian R. Porter, Brooklyn Park, MN (US); Scott R. Olson, St. Paul, MN (US)

(21) Appl. No.: 14/832,359

(22) Filed: Aug. 21, 2015

(51) Int. Cl. G06F 9/44

(52) U.S. Cl. CPC G06F 8/76

(57) ABSTRACT

Methods and apparatus to adapt legacy applications to target platforms are disclosed. An example method includes generating a platform-agnostic representation of a first platform-specific application, the first platform-specific application being specific to a first mobile platform, the platform-agnostic representation of the first platform-specific application conforming to a first API of the first mobile platform; and adapting the platform-agnostic representation of the first platform-specific application to be platform-specific to a second mobile platform different than the first mobile platform.

### FIELD OF DISCLOSURE

This disclosure relates generally to computing platforms and, more particularly, to methods and apparatus to adapt legacy applications to target platforms.

### BACKGROUND

Computing platforms execute applications (e.g., programs) reliably and at high performance levels. As such, computing platforms and the applications executed by the computing platforms provide valuable functionality. However, when a targeted computing platform for a given application needs to change, the resulting application development and maintenance effort represent a significant dedication of resources to modify the application to meet, for example, application programming interfaces (APIs) of the target computing platform.

### BRIEF DESCRIPTION OF THE DRAWINGS

FIG. 1 depicts an example computing environment including an application adapter constructed in accordance with teachings of this disclosure.

FIG. 2 is a block diagram of an example implementation of the application adaption module of FIG. 1.

FIG. 3 is a first example diagram illustrating example data associated with the example application adaption module of FIGS. 1 and/or 2.

FIG. 4 is a second example diagram illustrating example data associated with the example application adaption module of FIGS. 1 and/or 2.

FIG. 5 is a flowchart representative of example operations that may be executed to implement the example application adaption module of FIGS. 1 and/or 2.

FIG. 6 is a flowchart representative of example operations that may be executed to implement the example application adaption module of FIGS. 1 and/or 2.

FIG. 7 is a flowchart representative of example operations that may be executed to implement the example application adaption module of FIGS. 1 and/or 2.

FIG. 8 is a block diagram of an example logic circuit for implementing the example operations of FIGS. 5, 6, and/or 7 to implement the example application adaption module of FIGS. 1 and/or 2.

### DETAILED DESCRIPTION

Development of software, such as an application to be executed on a computing device, is a costly process. As such, an entity (e.g., an asset tracking company) that purchases, licenses, and/or internally develops an application (e.g., an asset tracking application) typically does so at a significant cost. Accordingly, entities are incentivized to utilize the application widely and over a long period of time. Benefits of continued use of the application may be expanded over time due to, for example, establishment of other systems and/or processes that are based on the application. Moreover, with extensive and prolonged use of the application, personnel become knowledgeable and efficient users of the application.

However, technology rapidly evolves. Hardware is improved due to advancements in fabrication, design, materials, etc. Software performance is increased due to new and improved techniques. Additionally, aspects of user interfaces, such as the theme or look and feel of user interface elements associated with an operating system, evolve over time. Accordingly, when new computing platforms are developed and manufactured, the new computing platforms include different hardware, different software, and/or different user interface experiences than did predecessor computing platforms. To enable personnel to reap the benefits of improved technology, the new computing platforms are adopted by entities such as, for example, entities that equip personnel with computing platforms.

In some instances, entities that adopt new and/or different computing platforms have purchased, licensed and/or internally developed one or more applications designed for execution on the predecessor computing platforms. For example, an asset tracking entity may have developed an asset tracking application based on the Microsoft .NET Compact Framework and used the asset tracking application on a predecessor Microsoft Windows mobile computing platform. That is, the asset tracking application was designed for the predecessor mobile computing platform used by the asset tracking entity. In some instances, when the asset tracking entity adopts the new and/or different mobile computing platform, currently utilized APIs may be unavailable. Moreover, performance and/or usability of the application on the new and/or different computing platform may be limited, restricted, poor and/or undesirable. For example, user interface elements of the asset tracking application may be severely outdated relative to the look and feel of the new and/or different computing platform. Additionally or alternatively, the application may not function correctly on the new and/or different computing platform. However, as described above, the asset tracking entity would realize a plurality of benefits if the application could function on the new and/or different computing platform.

Example methods, apparatus and articles of manufacture disclosed herein enable an application (e.g., program) that was originally designed for a first computing platform to be executed on a second computing platform such as, for example, a newer version of the first computing platform or a different computing platform. Additionally or alternatively, example methods, apparatus and articles of manufacture disclosed herein improve usability of the application on the second computing platform. The application that was originally designed for execution on the first computing platform is referred to herein as a legacy application. The first computing platform for which the legacy application was originally designed is referred to as a legacy computing platform. The second computing platform is referred to herein as a target computing platform.

As described in detail below, examples disclosed herein adapt legacy applications for execution on one or more target computing platforms. Examples disclosed herein adapt the legacy applications while maintaining the functionality of the legacy applications. In some examples, one or more aspects of the legacy applications are updated to correspond to a look and feel of the target computing platforms. For example, a list of items that was presented on a grid in the legacy computing platform may be updated by examples disclosed herein to be presented as a scrolling selection list when the typical manner in which lists are presented on the target computing platform is via a scrolling selection list. As such, examples disclosed herein provide an updated user experience for the legacy application on the target computing platform commensurate with the user experience provided by other applications executed on the target computing platform.

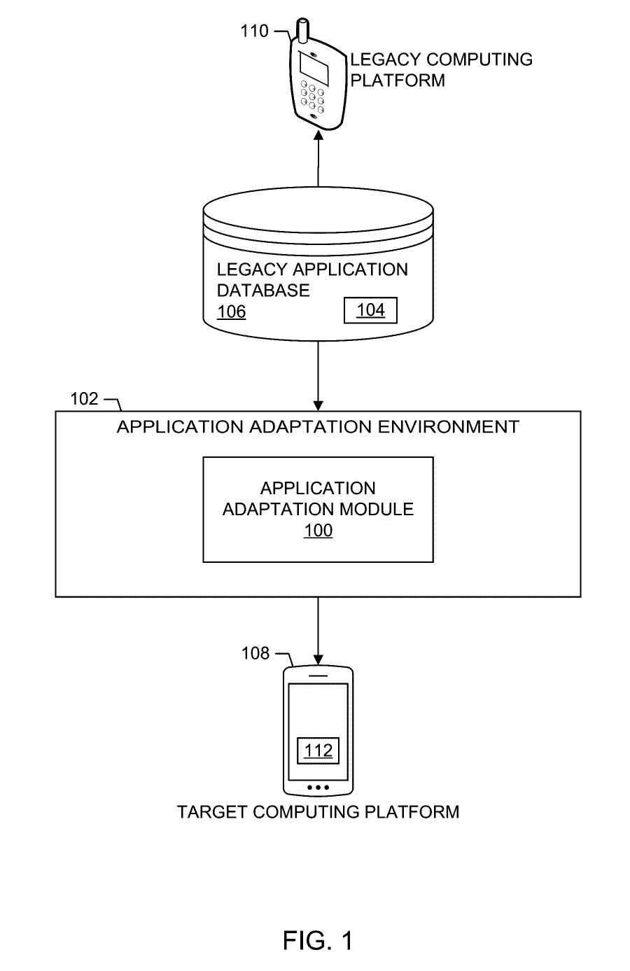

FIG. 1 is an example environment including an application adaptation module 100 constructed in accordance with teachings of this disclosure. In the example of FIG. 1, the application adaptation module 100 is implemented in an application adaptation environment 102. The example application adaptation environment 102 of FIG. 1 is a computing environment that is utilized to adapt one or more legacy applications for use on one or more target computing platforms in accordance with teachings of this disclosure. In the illustrated example of FIG. 1, the application adaptation environment 102 receives a legacy application 104 from a source of legacy applications such as, for example, a legacy application database 106 and/or any other type of storage. The example application adaptation environment 102 of FIG. 1 is tasked with adapting the legacy application 104 for use on a target computing platform 108. The example legacy application 104 of FIG. 1 was originally designed for execution on a legacy computing platform 110 that is older and/or different than the target computing platform 108. In the example of FIG. 1, the legacy application 104 is platform-specific to the legacy computing platform 110. That is, the legacy application 104 is linked to a specific technological aspect of the legacy computing platform 110 such as, for example, an operating system, a programming language, a set of user interface libraries, a specific data access mechanism, a file system, etc. Put another way, the legacy application 104 conforms to one or more configurations, architectures, and/or rules associated with the legacy computing platform 110. Accordingly, the example application adaptation environment 102 is tasked with adapting the legacy application 104, which is platform-specific application that conforms to the legacy computing platform 110, into a platform-specific target application 112 that conforms to the target computing platform 108. As disclosed in detail below, the example application adaptation module 100 of FIG. 1 provides the adaptation of the platform-specific legacy application 104 into the platform-specific target application 112. Moreover, as disclosed in detail below, the example application adaption module 100 of FIG. 1 may adapt the legacy application 104 into additional target applications for additional target computing platforms.

In the illustrated example of FIG. 1, the legacy computing platform 110 and the target computing platform 108 are mobile computing platforms. A computing platform is a framework on which applications can executed. Mobile computing platforms are generally computing devices that are designed to be carried by hand including, for example, telephones, smart phones, feature pones, tablet computers, netbook computers, notebook computers, handheld game devices, personal media players, in-vehicle computers, handheld scanners, etc. In the illustrated example, the target computing platform 108 includes one or more hardware components such as, for example, a barcode scanner, a camera, a thermal printhead, an RFID encode or a transponder. Mobile computing platforms are generally smaller in scale than desktop computing platforms (desktop computers, servers, televisions, set-top boxes, game consoles, etc.) and, thus, have different resources (e.g., less memory, less processing capabilities, etc.) than counterpart desktop computing platforms. As such, applications and/or versions of an application designed for mobile computing platforms are designed differently than applications and/or versions of an application designed for desktop computing platforms. Notably, the example application adaptation module 100 of FIG. 1 enables the legacy application 104 to be adapted into the target application 112 without having to rewrite code of the legacy application 104. Further, the example application adaptation module 100 enables full functionality of the legacy application 104 to be realized on the target computing platform 108 without rewriting the code of the legacy application 104.

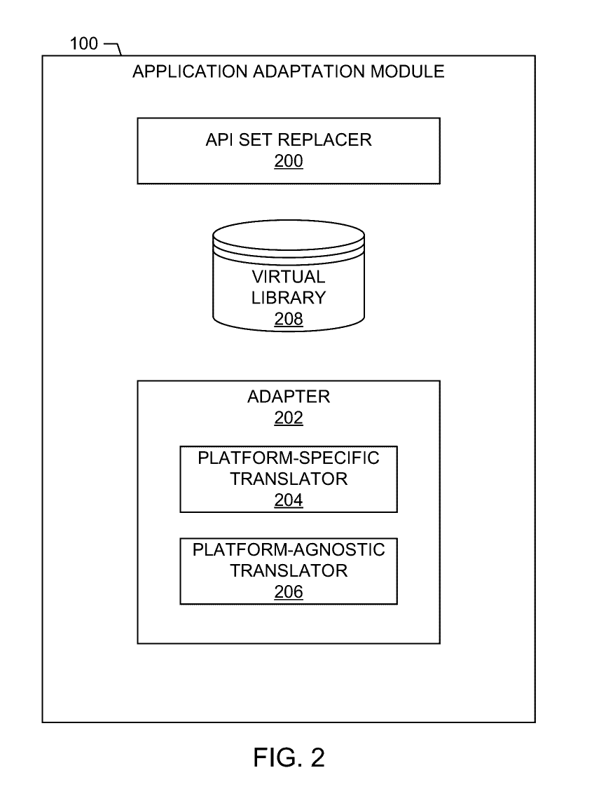

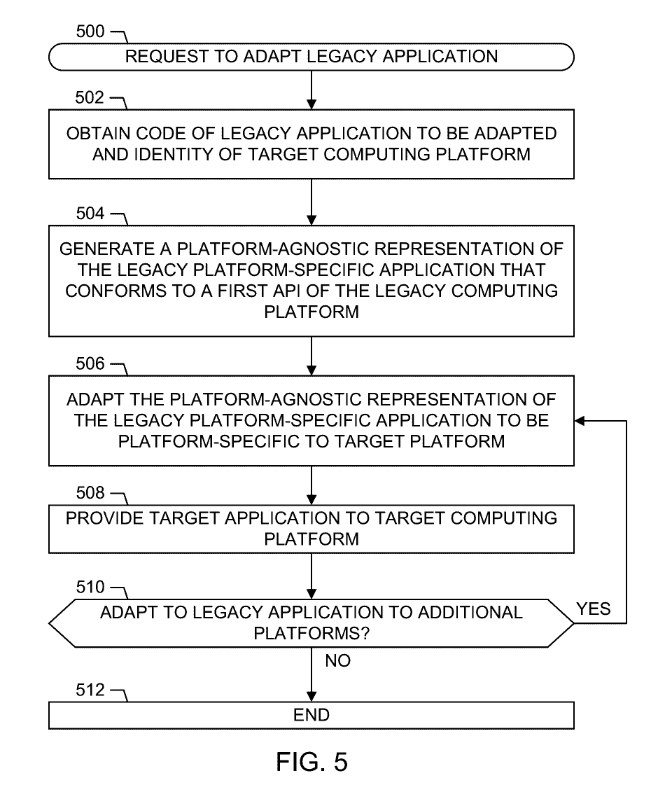

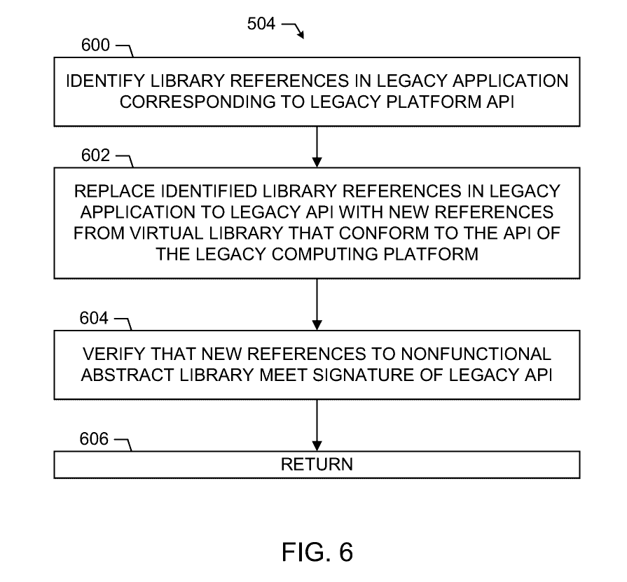

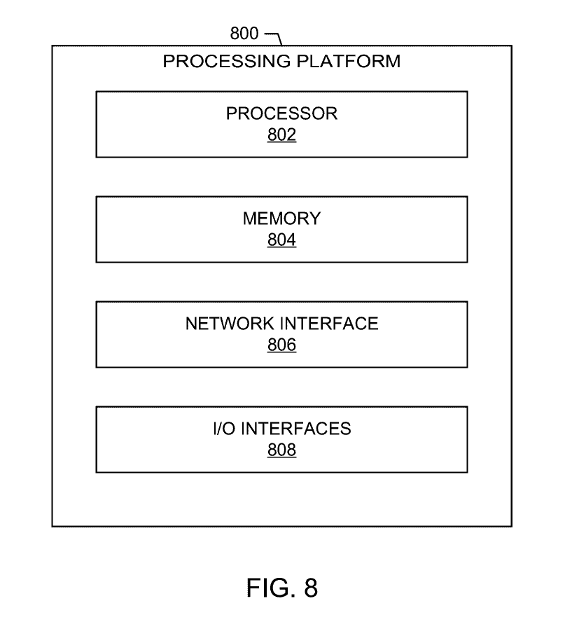

FIG. 2 is a block diagram of an example implementation of the application adaption module 100 of FIG. 1. The example implementation of the application adaptation module 100 illustrated in FIG. 2 includes an application programming interface (API) set replacer 200 and an adapter 202 including a platform-specific translator 204 and a platform-agnostic translator 206. Alternative implementations of the example application adaptation module 100 of FIG. 1 include one or more additional or alternative elements, processes and/or devices. Additionally or alternatively, one or more of the example API set replacer 200, the example adapter 202, the example platform-specific translator 204 and/or the example platform-agnostic translator 206 of FIG. 2 may be combined, divided, re-arranged or omitted. The example API set replacer 200, the example adapter 202, the example platform-specific translator 204, the example platform-agnostic translator 206 and/or, more generally, the example application adaption module 100 of FIGS. 1 and/or 2 is/are implemented by hardware, software, firmware, and/or any combination of hardware, software and/or firmware. In some examples, at least one of the example API set replacer 200, the example adapter 202, the example platform-specific translator 204, the example platform-agnostic translator 206 and/or, more generally, the example application adaption module 100 of FIGS. 1 and/or 2 is implemented by a logic circuit (e.g., the example processor 800 of FIG. 8). As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations of FIGS. 5, 6 and/or 7). Some example logic circuits are hardware that executes machine-readable instructions to perform operations (e.g., one or more of the operations of FIGS. 5, 6 and/or 7). Some example logic circuits include a combination of specifically configured hardware and hardware that executes machine-readable instructions.

The example application adaptation module 100 of FIG. 2 receives code associated with the legacy application 104 of FIG. 1. The code associated with the legacy application 104 of FIG. 1 is, for example, source code or compiled binary. The example application adaptation module 100 of FIG. 2 determines (e.g., via input identification data received in conjunction with the code associated with the legacy application 104) an identity of the target computing platform 108 for which the legacy application 104 is to be adapted. For example, the legacy application 104 may be platform-specific to a first operating system or framework associated with the legacy computing platform 110, and the application adaptation module 100 of FIG. 2 is tasked with generating the target application 112 that is platform-specific to a second operating system or framework associated with the target computing platform 108. In addition to the task of generating the target application 112 that is platform-specific to the second operating system or framework associated with the target computing platform 108, the example application adaptation module 100 may be tasked with generating one or more additional target applications that are respectively platform-specific to one or more other operating systems and/or frameworks associated with the target computing platform 108 and/or one or more other computing platforms.

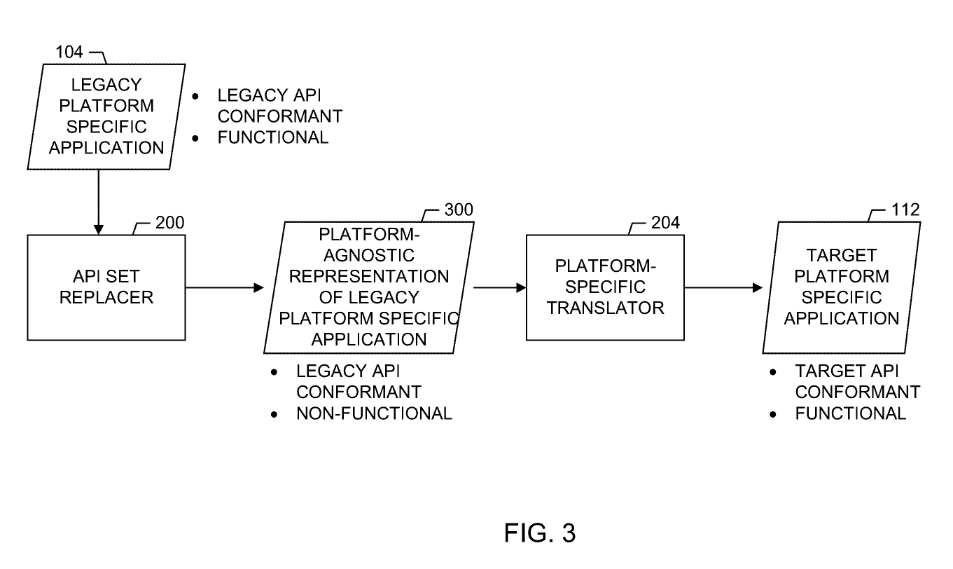

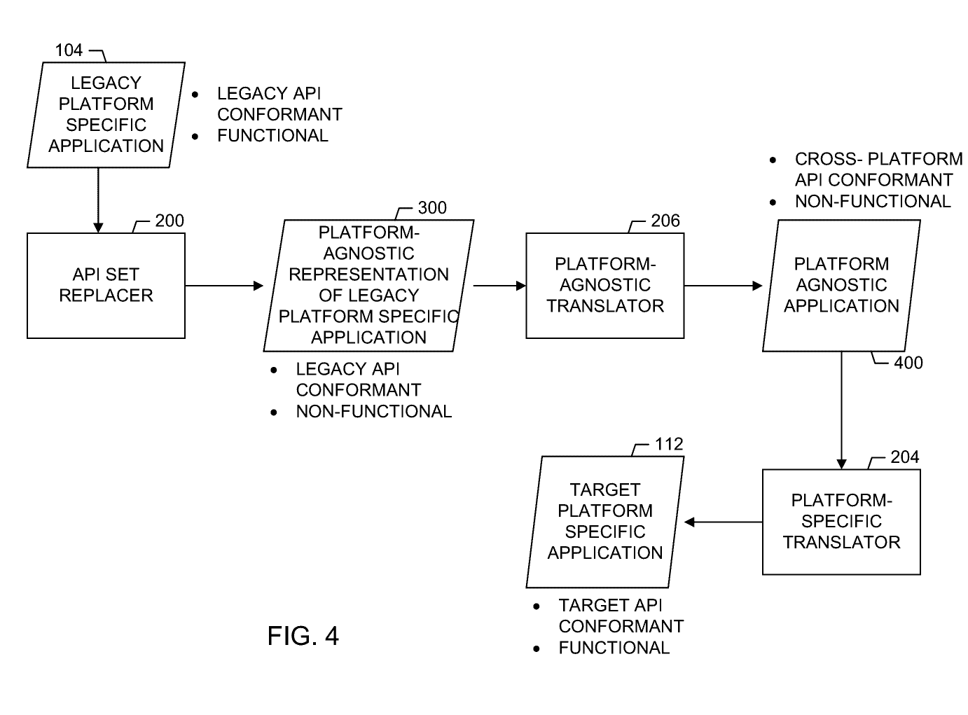

To adapt the legacy application 104 into the target application 112, the example application adaptation module 100 abstracts (e.g., maps) the legacy application 104 to a non-functional representation of the legacy application 104 and then translates the abstraction into the target application 112, which is functional. Example diagrams illustrating operations and data associated with the example application adaptation module 100 of FIG. 2 are shown in FIGS. 3 and 4. In particular, FIG. 3 illustrates example operations and data associated with an abstraction of the legacy application 104 and a direct translation into the target application 112. FIG. 4 illustrates example operations and data associated with an abstraction of the legacy application 104 and a multi-stage translation into the target application 112. FIG. 2 is described in conjunction with FIGS. 3 and 4. However, the example application adaptation module 100 of FIG. 2 may be implemented via additional or alternative operations and/or data.

In the illustrated example of FIG. 2, the example API set replacer 200 of FIG. 2 generates a platform-agnostic representation 300 (FIG. 3) of the legacy application 104 that conforms with an API of the legacy computing platform 110. In the illustrated example of FIG. 2, the API set replacer 200 generates the platform-agnostic representation 300 by replacing library references (e.g., Dynamically Linked Library references) corresponding to the APIs of the legacy computing platform 110 with different library references obtained from a virtual library 208 implemented by the application adaptation module 100, which provides the representation of the functional intent of the API of the legacy computing platform 110. Notably, the library references of the example virtual library 208 of FIG. 2 that are used by the API set replacer 200 to generate the platform-agnostic representation 300 of the legacy application 104 conform to the API of the legacy computing platform 110, but are nonfunctional. That is, the platform-agnostic representation 300 generated by the API set replacer 200 meets the same signature as the API of the legacy platform 110 but is incapable of being used directly to implement (e.g., execute) the application on an actual computing platform. Instead, the new library references that replaced the APIs of the legacy application 104 are abstract characterizations of the functionality of the legacy application 104. However, in some examples, the virtual library 208 can additionally include one or more functional representations of the APIs of the legacy application 104. For example, when a function (e.g., checking a level of a battery charge of the device) of the legacy application 104 has an equivalent (e.g., a reasonable equivalent or a direct equivalent) in the target computing platform 108, the functional representations of the virtual library 208 can be used in the target application 112. In such instances, the output of the function can be configured according to one or more aspects of the target computing platform 108.

In the illustrated example of FIG. 2, the new library references of the platform-agnostic representation 300 of the legacy application 104 are in-memory objects. However, additional or alternative implementations of the platform-agnostic representation 300 are possible.

The example adapter 202 of FIG. 2 adapts the platform-agnostic representation 300 of the legacy application 104 to be platform-specific to the target computing platform 108. In some examples, the adapter 202 adapts the platform-agnostic representation 300 of the legacy application 104 directly into the platform-specific target application 112 via the platform-specific translator 204. An example of such a direct translation is illustrated in FIG. 3. In particular, the example platform-specific translator 204 translates the platform-agnostic representation 300 of the legacy application 104 into the target application 112, which includes an API that conforms to the target computing platform 108. Put another way, the example platform-specific translator 204 of FIG. 2 converts the nonfunctional abstraction (e.g., the platform-agnostic representation 300) of the legacy application 104 generated by the API set replacer 200 into a functional, concrete API that can be used to implement the target application 112 on the target computing platform 108. The example platform-specific translator 204 of FIG. 2 binds the example API set replacer 200 to the target computing platform 108 (e.g., via identification data received in conjunction with the request for the adaptation of the legacy application) and uses a knowledge base (e.g., API definitions and/or configurations, binding source code, sets of bindings, etc.) associated with the target computing platform 108 to generate the functional, concrete API that can be used to implement the target application 112 on the target computing platform 108, which implements the appropriate API on the target computing platform 108 that fulfills the functional intent of the nonfunctional abstraction. In such instances, the functional target API generated by the example platform-specific translator 204 is different than the API of the legacy computing platform 110, but maintains the functionality of the legacy application 104. Instead, the functional target API of the target application 112 is specific to the target computing platform 108.

For example, a user interface element (e.g., a list or message box) may be presented on the target computing platform 108 in accordance with the functional target API in a manner different from the presentation of the same user interface element on the legacy computing platform 110. In some examples, the user interface element is presented on the target computing platform 108, as enabled by the functional target API generated by the platform-specific translator 204, to correspond to a look and feel associated with the target computing platform 108. However, the functionality (e.g., logic) of the legacy application 104 is maintained on the target computing platform 108 via the functional target API of the target application 112. If the legacy application 104 is to be adapted to one or more additional target computing platforms, the example platform-specific translator 204 of FIG. 2 can generate one or more additional functional, platform-specific APIs based on the platform-agnostic representation 300 of the legacy application 104. In some examples, the platform-specific translator 204 of FIG. 2 may generate a container for each of the target applications such that the target applications can be distributed to the target computing platforms. In some examples, before distributing the example target application 112, the example application adaptation module 100 complies layers of the target application 112 (e.g., application source code, layer source code, container source code, and/or binding source code). Additionally or alternatively, one or more aspects of the compiling may be performed on the target computing device 108.

Alternatively, as illustrated in FIG. 4, the example adapter 202 of FIG. 2 uses the example platform-agnostic translator 206 and the platform-specific translator 204 to adapt the platform-agnostic representation 300 of the legacy application 104. Similar to the example of FIG. 3, the example API set replacer 200 of FIG. 2 generates the platform-agnostic representation 300 of the legacy application 104. Similar to the example of FIG. 3, the platform-agnostic representation 300 conforms to the API of the legacy application 104 and is nonfunctional (e.g., cannot be used directly to execute an application). In the example of FIG. 4, the example platform-agnostic translator 206 translates the platform-agnostic representation 300 of the legacy application 104 into a platform-agnostic application 400 having a nonfunctional API that is cross-platform API conformant according to the appropriate interpretation of the functional intent of the nonfunctional APIs of the legacy application 104. In particular, the example platform-agnostic translator 206 of FIG. 2 generates a plurality of links or references to the platform-agnostic representation 300 of the legacy application 104. The links or references generated by the example platform-agnostic translator 206 of FIG. 2 refer to the library references of the platform-agnostic representation 300 of the legacy application 104 in a manner that enables any platform to interface with the library references. For example, when the platform-agnostic representation 300 of the legacy application 104 is implemented by a virtual form, which represents a nonfunctional segment of the legacy application 104 user interface, the example platform-agnostic application 400 generated by the platform-agnostic translator 206 includes links or references to the virtual form. Put another way, the example platform-agnostic translator 206 of FIG. 2 generates a nonfunctional cross-platform abstraction of the platform-agnostic representation 300 of the legacy application 104. In some examples, the translation(s) performed platform-agnostic translator 206 include one or more refinements in and/or additions to, for example, a user experience functionality that adapts the functional intent of the legacy application 104 to the target computing platform 108. That is, the example platform-agnostic translator 206 of FIG. 2 tailors the platform-agnostic application 400 according to one or more differences between the legacy computing platform 110 and the target computing platform 108.

In the illustrated example, the platform-agnostic translator 206 provides the platform-specific translator 204 with the platform-agnostic application 400 having the nonfunctional API that is cross-platform conformant. When the example platform-specific translator 204 of FIG. 2 receives the platform-agnostic application 400, the platform-specific translator 204 determines an identity of the target computing platform 108 (e.g., based on identification data received in conjunction with the request for adaptation of the legacy application 104). Using the identity of the target computing platform 108 and the API knowledge base associated with the target computing platform 108, the example platform-specific translator 204 translates the platform-agnostic application 400 into the target application 112 having the functional API that conforms to the target computing platform 108. The example platform-specific translator 204 of FIG. 2 can translate the platform-agnostic application 400 into one or more additional target applications for one or more target computing platforms. In some examples, the example adapter 202 includes additional platform-specific translators each corresponding to the different target computing platforms.

When the target computing platform 108 is provided with the target application 112, the functionality of the legacy application 104 may be executed on the target computing platform 108 in accordance with a look and feel of the target computing platform 108. For example, the functionality of the legacy application 104 may include displaying a message box or a form. When a function call to the message box or form is encountered, the target computing platform 108 utilizes the functional target API of the target application 112 rather than the API of the legacy computing platform 110. As described above, the target API of the target application 112 meets the API signature of the legacy computing platform 110, but is adapted to the target computing platform 108. For example, the target API of the target application 112 maps the function call of the message box or form to a platform-specific implementation of a message box or form according to the target computing platform 108. Thus, when the message box or form is displayed on the legacy computing platform 110 in a first manner, the target application 112 enables the same function (e.g., message box or form) implemented in a second manner different than the first manner that corresponds to, for example, display parameters associated with an operating system of the target computing platform 108. Put another way, the example application adaptation module 100 of FIG. 2 enables the target computing platform 108 to execute the functionality of the legacy application 104 via an implementation that includes display layers familiar to the target computing platform 108.

Alternatively, when a function call to a hardware component (e.g., a barcode scanner) is encountered, the target computing platform 108 utilizes the functional target API of the target application 112 rather than the API of the legacy computing platform 110. The hardware component of the target computing platform 108 may be different (e.g. newer) than the corresponding hardware component of the legacy computing platform 110. Therefore, the example target application 112 enables the function call to be mapped to a platform-specific hardware component function (e.g., barcode scan) that corresponds to the target computing platform 108.

FIGS. 5-7 are flowcharts representative of example operations for implementing the example application adaptation module 100 of FIGS. 1 and/or 2. Alternative example implementations of the application adaptation module 100 of FIGS. 1 and/or 2 include one or more additional or alternative operations. Additionally or alternatively, one or more of the operations of the example flowcharts of FIGS. 5-7 may be combined, divided, re-arranged or omitted. In some examples, the operations of FIGS. 5-7 are implemented by machine-readable instructions (e.g., software and/or firmware) stored on a medium (e.g., a tangible machine-readable medium) for execution by one or more logic circuits (e.g., processor(s)). In some examples, the operations of FIGS. 5-7 are implemented by one or more configurations of one or more specifically designed logic circuits (e.g., ASIC(s)). In some examples the operations of FIGS. 5-7 are implemented by a combination of machine-readable instructions stored on a medium (e.g., a tangible machine-readable medium) for execution by one or more logic circuits and one or more specifically designed logic circuits.

As used herein, each of the terms “tangible machine-readable medium,” “non-transitory machine-readable medium,” “machine-readable storage device” and “article of manufacture” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium,” “machine-readable storage device” and “article of manufacture” is expressly defined to exclude propagating signals. That is, as used in any claim of this patent, none of the terms “tangible machine-readable medium,” “non-transitory machine-readable medium,” “machine-readable storage device” and “article of manufacture” can be read to be implemented by a propagating signal. Further, as used herein, each of the terms “tangible machine-readable medium,” “non-transitory machine-readable medium,” “machine-readable storage device” and “article of manufacture” is expressly defined as a storage medium on which machine-readable instructions are stored for any suitable duration of time (e.g., permanently, an extended period of time (e.g., while a program associated with the machine-readable instructions is executing), and/or a short period of time (e.g., while the machine-readable instructions are cached and/or during a buffering process). As used herein, the term “at least” is open-ended in the same manner as the term “comprising” is open-ended.

The example of FIG. 5 starts with a request for the example application adaptation module 100 of FIG. 1 and/or to adapt the example legacy application 104 for execution on the target computing platform 108 (block 500). In the illustrated example, the legacy application 104 is platform-specific to the legacy computing platform 110 and conforms to the API of the legacy computing platform 110. In the example of FIG. 5, the adaptation application module 100 obtains code (e.g., source code and/or compiled binary) of the legacy application 104 and identification data indicative of an identity of the target computing platform 108 (block 502). For example, the application adaptation module 100 may obtain information indicating that the target computing platform 108 utilizes a particular operating system and/or framework.

In the example of FIG. 5, the API set replacer 200 of FIG. 2 generates a platform-agnostic representation (e.g., the platform-agnostic representation 300 of FIGS. 3 and/or 4) of the legacy application 104 that conforms to the API of the legacy computing platform (block 504). The platform-agnostic representation of the legacy application 104 generated by the example API set replacer 200 meets the API signature of the legacy computing platform 110 but is nonfunctional. An example implementation of block 504 is described below in connection with FIG. 6.

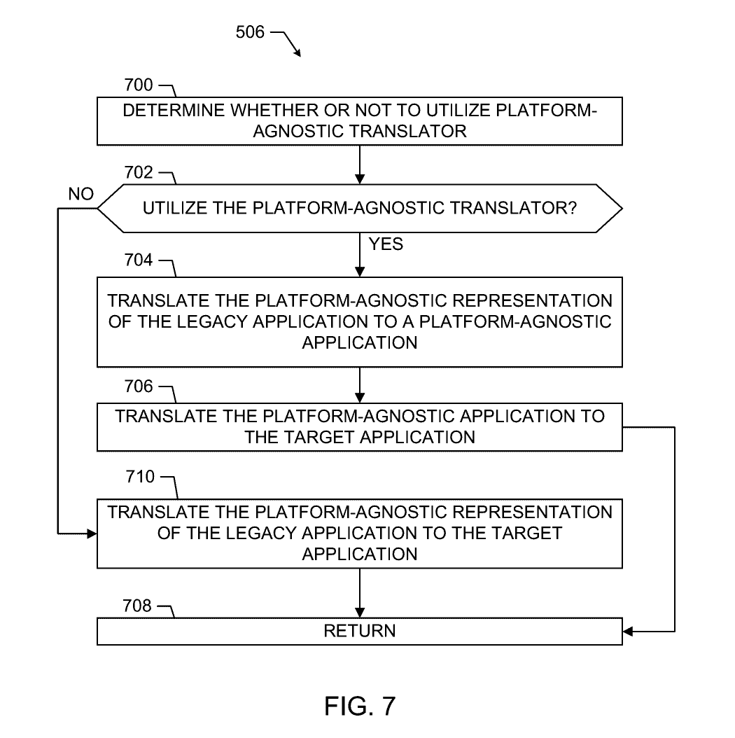

In the example of FIG. 5, the example adapter 202 of FIG. 2 adapts the platform-agnostic representation of the legacy application 104 to be platform-specific to the target computing platform 108 (block 506). The target application 112 generated by the adapter 202 is functional, conforms to the API of the target computing platform 108, and differs from the API of the legacy computing platform 110. An example implementation of block 506 is described below in connection with FIG. 7.

In the example of FIG. 5, the example application adaptation module 100 provides the target application 112 to the target computing platform 108 (block 508). In some examples, the application adaptation module 100 compiles the target application 112 before providing the target application 112 to the target computing platform 108. In some examples, one or more aspects of the compiling is performed by the example target computing platform 108. The example application adaptation module 100 determines whether additional adaptations of the legacy application 104 have been requested (block 510). If one or more additional adaptations of the legacy application 104 have been requested (block 510), control proceeds to block 506. If no additional adaptations of the legacy application 104 have been requested (block 510), the example of FIG. 5 ends (block 512).

FIG. 6 illustrates an example implementation of block 504 of FIG. 5, which corresponds to the generation of the platform-agnostic representation (e.g., the platform-agnostic representation 300 of FIGS. 3 and/or 4) of the legacy application 104. In the example of FIG. 6, the API set replacer 200 identifies library references (e.g., DLL references) corresponding to the API of the legacy computing platform 110 (block 600). For example, the API set replacer 200 scans code of the legacy API to identify the library references and or sets of library references. Further, the example API set replacer 200 of FIG. 2 replaces the identified library references with different library references obtained from the virtual library 208 (block 602). The different library references of the platform-agnostic representation are conformant to the API of the legacy computing platform 110, but are abstract nonfunctional. Accordingly, in the example of FIG. 6, the API set replacer 200 verifies that the new library references that replaced the legacy library references meet the signature of the API of the legacy computing platform 110. In the example of FIG. 6, control returns to block 506 of FIG. 5 (block 606).

FIG. 7 illustrates an example implementation of block 506 of FIG. 5, which corresponds to the adaptation of the platform-agnostic representation of the legacy application 104 to be platform-specific to the target computing platform 108. In the example of FIG. 7, the adapter 202 determines whether the platform-agnostic translator 206 is to be utilized for the instant adaptation (block 700). This determination is based on, for example, whether the legacy application 104 is to be adapted for multiple target computing platforms. However, additional or alternative criteria (e.g., user preference, default settings, etc.) for the determination are possible. If the platform-agnostic translator 206 is to be utilized (block 702), the example API set replacer 200 provides the platform-agnostic representation of the legacy application 104 to the platform-agnostic translator 206, which translates the platform-agnostic representation of the legacy application to a platform-agnostic application (e.g., the platform agnostic application 400 of FIG. 4) (block 704). In the illustrated example, the platform-agnostic application is cross-platform conformant (e.g., conforms to any mobile computing platform) and is nonfunctional (e.g., cannot be used directly to execute the application). In the example of FIG. 7, the platform-specific translator 204 translates the platform-agnostic application to the target application 112, which includes a functional API (e.g., can be used directly to execute the target application 112 on the target computing platform 108) that meets the signature of the API of the legacy computing platform 110. Control then proceeds back to block 508 of FIG. 5 (block 708).

Referring back to block 702, when the platform-agnostic translator 206 is to be used, control proceeds to block 710. In such instances, the example API set replacer 200 provides the platform-agnostic representation of the legacy application 104 to the platform-specific translator 204, which translates the platform-agnostic representation into the target application 112. Control then proceeds to block 508 of FIG. 5 (block 708).

FIG. 8 is a block diagram representative of an example logic circuit that may utilized to implement, for example, the application adaptation module 100 of FIGS. 1 and/or 2. The example logic circuit of FIG. 8 is a processing platform 800 capable of executing instructions to, for example, implement the example operations of FIGS. 5, 6 and/or 7.

The example processing platform 800 of FIG. 8 includes a processor 802 such as, for example, one or more microprocessors, controllers, and/or any suitable type of processor. The example processing platform 800 of FIG. 8 includes memory (e.g., volatile memory, non-volatile memory) accessible by the processor 802 (e.g., via a memory controller). The example processor 802 interacts with the memory 804 to obtain, for example, machine-readable instructions stored in the memory 804 corresponding to, for example, the operations of FIGS. 5, 6 and/or 7. Additionally or alternatively, machine-readable instructions corresponding to the example operations of FIGS. 5, 6 and/or 7 may be stored on one or more removable media (e.g., a compact disc, a digital versatile disc, removable flash memory, etc.) that may be coupled to the processing platform 800 to provide access to the machine-readable instructions stored thereon.

The example processing platform 800 of FIG. 8 includes a network interface 806 to enable communication with other machines via, for example, one or more networks. The example network interface 806 includes any suitable type of communication interface(s) (e.g., wired and/or wireless interfaces) configured to operate in accordance with any suitable protocol(s).

The example processing platform 800 of FIG. 8 includes input/output (I/O) interfaces 808 to enable receipt of user input and communication of output data to the user.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A method, comprising:
generating, via a logic circuit, a platform-agnostic representation of a first platform-specific application, the first platform-specific application being specific to a first mobile platform, the platform-agnostic representation of the first platform-specific application conforming to a first API of the first mobile platform; and
adapting, via the logic circuit, the platform-agnostic representation of the first platform-specific application to be platform-specific to a second mobile platform different than the first mobile platform.

2. A method as defined in claim 1, wherein the platform-agnostic representation of the first platform-specific application is nonfunctional before the adapting of the platform-agnostic representation of the first platform-specific application to be platform-specific to the second mobile platform.

3. A method as defined in claim 1, wherein the adapting of the platform-agnostic representation of the first platform-specific application to be platform-specific to the second mobile platform includes translating the first platform-agnostic representation of the first platform-specific application to a second platform-specific application including a second API different than the first API, the second API conforming to the second mobile platform.

4. A method as defined in claim 3, further comprising adapting the platform-agnostic representation of the first platform-specific application to be platform-specific to a third mobile platform different than the first mobile platform and the second mobile platform by translating the first platform-agnostic representation of the first platform-specific application to a third platform-specific application including a third API different than the first and second APIs, the third API conforming to the third mobile platform.

5. A method as defined in claim 1, wherein the adapting of the platform-agnostic representation of the first platform-specific application to be platform-specific to the second mobile platform includes:
translating the platform-agnostic representation of the first platform-specific application to a platform-agnostic application including a second API different than the first API, the second API being platform-agnostic; and
translating the platform-agnostic application to second platform-specific application including a third API different than the first and second APIs, the third API conforming to the second mobile platform.

6. A method as defined in claim 5, further comprising adapting the platform-agnostic representation of the first platform-specific application to be platform-specific to a third mobile platform by translating the platform-agnostic application to a third platform-specific application including a fourth API different that the first, second and third APIs, the fourth API conforming to the third mobile platform.

7. A method as defined in claim 5, wherein:
the platform-agnostic representation of the first platform-specific application is non-functional before the adapting of the platform-agnostic representation of the first platform-specific application to be platform-specific to the second mobile platform; and
the second API is non-functional.

8. A method as defined in claim 1, wherein the platform-agnostic representation of the first platform-specific application is a plurality of in-memory objects.

9. A method as defined in claim 8, wherein the in-memory objects cannot be used directly to execute functionality of the first platform-specific application.

10. A method as defined in claim 1, wherein the adapting of the platform-agnostic representation of the first platform-specific application to be platform-specific to the second mobile platform comprises generating a second platform-specific application that is specific to the second mobile platform.

11. A tangible machine-readable medium comprising instructions that, when executed, cause a machine to at least:
generate a platform-agnostic representation of a first platform-specific application, the first platform-specific application being specific to a first mobile platform, the platform-agnostic representation of the first platform-specific application conforming to a first API of the first mobile platform; and
adapt the platform-agnostic representation of the first platform-specific application to be platform-specific to a second mobile platform different than the first mobile platform.

12. A tangible machine-readable medium as defined in claim 11, wherein the platform-agnostic representation of the first platform-specific application is nonfunctional before the adapting of the platform-agnostic representation of the first platform-specific application to be platform-specific to the second mobile platform.

13. A tangible machine-readable medium as defined in claim 11, wherein instructions, when executed, cause the machine to adapt the platform-agnostic representation of the first platform-specific application to be platform-specific to the second mobile platform by translating the first platform-agnostic representation of the first platform-specific application to a second platform-specific application including a second API different than the first API, the second API conforming to the second mobile platform.

14. A tangible machine-readable medium as defined in claim 13, wherein the instructions, when executed, cause the machine to adapt the platform-agnostic representation of the first platform-specific application to be platform-specific to a third mobile platform different than the first mobile platform and the second mobile platform by translating the first platform-agnostic representation of the first platform-specific application to a third platform-specific application including a third API different than the first and second APIs, the third API conforming to the third mobile platform.

15. A tangible machine-readable medium as defined in claim 11, wherein the instructions, when executed, cause the machine to adapt the platform-agnostic representation of the first platform-specific application to be platform-specific to the second mobile platform by:
translating the platform-agnostic representation of the first platform-specific application to a platform-agnostic application including a second API different than the first API, the second API being platform-agnostic; and
translating the platform-agnostic application to second platform-specific application including a third API different than the first and second APIs, the third API conforming to the second mobile platform.

16. A tangible machine-readable medium as defined in claim 15, wherein the instructions, when executed, cause the machine to adapt the platform-agnostic representation of the first platform-specific application to be platform-specific to a third mobile platform by translating the platform-agnostic application to a third platform-specific application including a fourth API different that the first, second and third APIs, the fourth API conforming to the third mobile platform.

17. A tangible machine-readable medium as defined in claim 15, wherein:
the platform-agnostic representation of the first platform-specific application is non-functional before the adapting of the platform-agnostic representation of the first platform-specific application to be platform-specific to the second mobile platform; and
the second API is non-functional.

18. A tangible machine-readable medium as defined in claim 11, wherein the platform-agnostic representation of the first platform-specific application is a plurality of in-memory objects.

19. A tangible machine-readable medium as defined in claim 18, wherein the in-memory objects cannot be used directly to execute functionality of the first platform-specific application.

20. A tangible machine-readable medium as defined in claim 11, wherein the instructions, when executed, cause the machine to adapt the platform-agnostic representation of the first platform-specific application to be platform-specific to the second mobile platform by generating a second platform-specific application that is specific to the second mobile platform.

21. An apparatus, comprising:
a replacer to generate a platform-agnostic representation of a first platform-specific application, the first platform-specific application being specific to a first mobile platform, the platform-agnostic representation of the first platform-specific application conforming to a first API of the first mobile platform; and
an adapter to adapt the platform-agnostic representation of the first platform-specific application to be platform-specific to a second mobile platform different than the first mobile platform, wherein at least one of the replacer or the adapter is implemented via a logic circuit.

22. An apparatus as defined in claim 21, wherein the platform-agnostic representation of the first platform-specific application is nonfunctional before the adapting of the platform-agnostic representation of the first platform-specific application to be platform-specific to the second mobile platform.

23. An apparatus as defined in claim 21, wherein the adapter is to adapt the platform-agnostic representation of the first platform-specific application to be platform-specific to the second mobile platform by translating the first platform-agnostic representation of the first platform-specific application to a second platform-specific application including a second API different than the first API, the second API conforming to the second mobile platform.

24. An apparatus as defined in claim 23, wherein the adapter is to adapt the platform-agnostic representation of the first platform-specific application to be platform-specific to a third mobile platform different than the first mobile platform and the second mobile platform by translating the first platform-agnostic representation of the first platform-specific application to a third platform-specific application including a third API different than the first and second APIs, the third API conforming to the third mobile platform.

25. An apparatus as defined in claim 21, wherein the adapter is to adapt the platform-agnostic representation of the first platform-specific application to be platform-specific to the second mobile platform by:
translating the platform-agnostic representation of the first platform-specific application to a platform-agnostic application including a second API different than the first API, the second API being platform-agnostic; and
translating the platform-agnostic application to second platform-specific application including a third API different than the first and second APIs, the third API conforming to the second mobile platform.

26. An apparatus as defined in claim 25, wherein the adapter is to adapt the platform-agnostic representation of the first platform-specific application to be platform-specific to a third mobile platform by translating the platform-agnostic application to a third platform-specific application including a fourth API different that the first, second and third APIs, the fourth API conforming to the third mobile platform.

27. An apparatus as defined in claim 25, wherein:
the platform-agnostic representation of the first platform-specific application is non-functional before the adapting of the platform-agnostic representation of the first platform-specific application to be platform-specific to the second mobile platform; and
the second API is non-functional.

28. An apparatus as defined in claim 21, wherein the adapter is to adapt the platform-agnostic representation of the first platform-specific application to be platform-specific to the second mobile platform by generating a second platform-specific application that is specific to the second mobile platform.
